(19) United States
(12) Patent Application Publication
(10) Pub. No.: US 2012/0154538 A1
(43) Pub. Date: Jun. 21, 2012

(54) IMAGE PROCESSING APPARATUS AND IMAGE PROCESSING METHOD

(75) Inventors: Tamotsu HASEGAWA, Tokyo (JP); Takashi Kumagai, Kawasaki-shi (JP); Nobuyuki Ikeda, Fuchu-shi (JP)

(73) Assignee: KABUSHIKI KAISHA TOSHIBA, Tokyo (JP)

(21) Appl. No.: 13/299,611

(22) Filed: Nov. 18, 2011

(30) Foreign Application Priority Data
Dec. 21, 2010 (JP) 2010-284580

(51) Int. Cl. H04N 13/02

(52) U.S. Cl. 348/46; 348/E13.074

(57) ABSTRACT

According to one embodiment, an image processing apparatus including background image generator which generates background image, receiver which receives additional information, depth calculator which determines first depth based on additional information, and calculates second depth based on first depth, first three-dimensional image generator which generates first object image based on additional information, and generates first three-dimensional image based on first object image and first depth, second three-dimensional image generator which generates second object image based on additional information, and generates second three-dimensional image based on second object image and second depth, at least part of second three-dimensional image being displayed in area overlapping first three-dimensional image, image composite module which generates video signal by displaying background image, displaying second three-dimensional image in front of displayed background image, and displaying first three-dimensional image in front of displayed second three-dimensional image, and output module which outputs video signal.

### CROSS-REFERENCE TO RELATED APPLICATIONS

This application is based upon and claims the benefit of priority from prior Japanese Patent Application No. 2010-284580, filed Dec. 21, 2010, the entire contents of which are incorporated herein by reference.

### FIELD

Embodiments described herein relate generally to an image processing apparatus and image processing method.

### BACKGROUND

In recent years, image processing apparatuses (three-dimensional image display apparatuses) have been put into practical use which can cause the user to cognize a two-dimensional image as an image with solidity. The three-dimensional image display apparatuses display a left-eye image which can be cognized only with the left eye and a right-eye image which can be cognized only with the right eye on a display module. The image processing apparatuses can cause the user to recognize the image as a three-dimensional image, by causing the user's left eye to cognize the left-eye image and causing the user's right eye to cognize the right-eye image.

When a three-dimensional image is recognized by causing the user's eyes to cognize different images, how the three-dimensional image is viewed and projected for the user is different person to person. In addition, there is the problem that the user may not be able to effectively recognize a three-dimensional image since the user is used to viewing a three-dimensional image.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view shown for explaining a three-dimensional display apparatus according to an embodiment.

FIG. 2 is an exemplary view shown for explaining an image processing apparatus according to the embodiment.

FIG. 3 is an exemplary view shown for explaining the image processing apparatus according to the embodiment.

FIG. 4 is an exemplary view shown for explaining the image processing apparatus according to the embodiment.

FIG. 5 is an exemplary view shown for explaining the image processing apparatus according to the embodiment.

FIG. 6 is an exemplary view shown for explaining the image processing apparatus according to the embodiment.

FIG. 7 is an exemplary view shown for explaining the image processing apparatus according to the embodiment.

FIG. 8 is an exemplary view shown for explaining the image processing apparatus according to the embodiment.

FIG. 9 is an exemplary view shown for explaining the image processing apparatus according to the embodiment.

FIG. 10 is an exemplary view shown for explaining the image processing apparatus according to the embodiment.

### DETAILED DESCRIPTION

Various embodiments will be described hereinafter with reference to the accompanying drawings.

In general, according to one embodiment, an image processing apparatus comprises, a background image generator which generates a background image; a receiver which receives additional information; a depth calculator which determines a first depth based on the additional information, and calculates a second depth based on the first depth; a first three-dimensional image generator which generates a first object image based on the additional information, and generates a first three-dimensional image based on the first object image and the first depth; a second three-dimensional image generator which generates a second object image based on the additional information, and generates a second three-dimensional image based on the second object image and the second depth, at least part of the second three-dimensional image being displayed in an area overlapping the first three-dimensional image; an image composite module which generates a video signal by displaying the background image, displaying the second three-dimensional image in front of the displayed background image, and displaying the first three-dimensional image in front of the displayed second three-dimensional image; and an output module which outputs the video signal generated by the image composite module.

An image processing apparatus and an image processing method according to an embodiment will be explained hereinafter with reference to drawings.

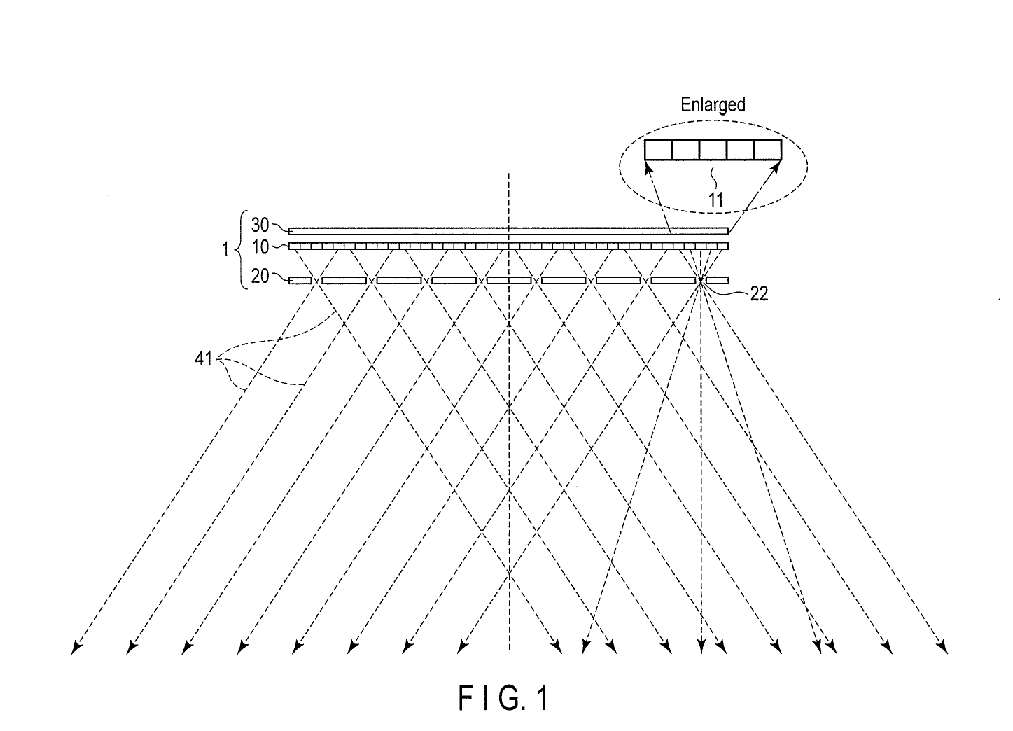

FIG. 1 is an exemplary view shown for explaining a three-dimensional display apparatus 1 according to the embodiment.

First, the principle of three-dimensional image display will be explained hereinafter. FIG. 1 is a diagram illustrating a cross section of a part of the three-dimensional display apparatus.

The three-dimensional display apparatus 1 comprises a display unit 10, a mask 20, and a backlight 30. The display unit 10 includes a number of pixels 10 which are arranged in rows and columns. The mask 20 includes a number of window parts 22. The mask 20 is disposed apart from the display unit 10 by a predetermined distance. The window parts 22 are provided in positions corresponding to the pixels 11.

The mask 20 includes optical openings which transmit light. The mask 20 has a function of controlling light beams emitted from the pixels 11. The mask 20 is also referred to as a parallax barrier or a light beam control element.

The mask 20 is formed of, for example, a transparent board in which a light-shield pattern is formed by a number of openings which correspond to the window parts 22. The mask 20 is formed of, for example, a light-shielding board in which a number of through holes that correspond to the window parts 22 are formed.

The mask 20 may be formed of a fly-eye lens which is formed by arranging a number of minute lenses in a two-dimensional manner. The mask 20 may be formed of, for example, a lenticular lens which is formed by periodically arranging a plurality of optical openings, which extend in a straight line in a vertical direction, in a horizontal direction. The arrangement, size, and shape of the mask 20 may be changed as desired according to the arrangement of the pixels 11 of the display unit 10.

The backlight 30 is a light source which emits light. The backlight 30 includes a light source such as a cold cathode-ray tube and an LED device. The light emitted from the backlight 30 is transmitted through the pixels 11 of the display unit 10, and passes through the mask 20. Each pixel 11 of the display unit 10 polarizes the transmitted light. Thereby, each of the pixels 11 can display various colors.

In addition, the mask 20 transmits light emitted from the pixels 11 which exist in a straight line with the respective window parts 22. Consequently, the three-dimensional display apparatus 1 can emit light beams of various colors in directions of light beams 41 illustrated in FIG. 1.

As described above, although the present embodiment shows an example of three-dimensional display by an integral method, the three-dimensional display apparatus 1 is not limited to the above structure. The three-dimensional display method of the three-dimensional display apparatus 1 may be other methods such as a naked-eye method, a shutter-spectacle method, and a polarizing spectacle method.

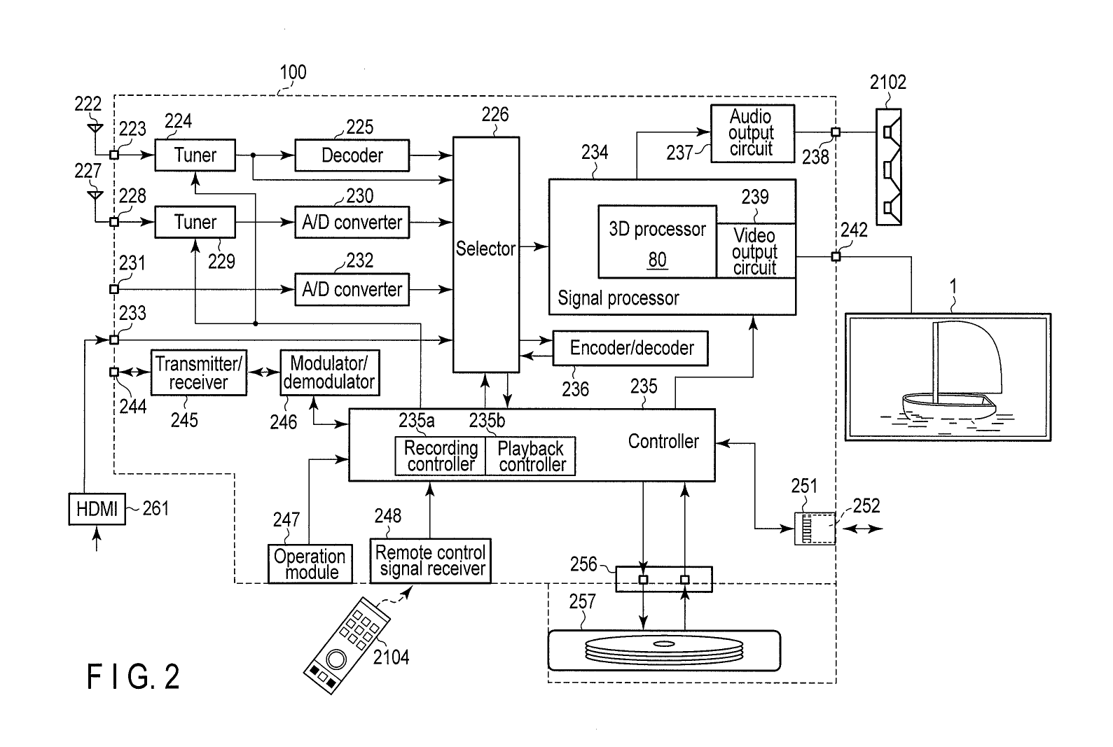

FIG. 2 is an exemplary view shown for explaining an image processing apparatus 100 according to the embodiment. The image processing apparatus 100 includes an input terminal 223, a tuner 224, a decoder 225, and a selector 226.

The input terminal 223 is an input terminal to which a digital broadcasting signal received by an antenna 222 is input. The antenna 222 receives, for example, a ground-wave digital broadcasting signal, a BS (broadcasting satellite) digital broadcasting signal, and/or a 110° CS (communication satellite) digital broadcasting signal. Specifically, the input terminal 223 receives content such as a program supplied by the broadcasting signal.

The input terminal 223 supplies the received digital broadcasting signal to the tuner 224. The tuner 224 is a tuner for digital broadcasting signals. The tuner 224 performs tuning (selection) of the digital broadcasting signal supplied from the antenna 222. The tuner 224 transmits the tuned digital broadcasting signal to the decoder 225.

The decoder 225 demodulates the digital broadcasting signal supplied from the tuner 224. The decoder 225 inputs the demodulated digital broadcasting signal (content) to the selector 226. Specifically, the input terminal 223, the tuner 224, and the decoder 225 function as receiving means for receiving content. When the signal received by the input terminal 223 is not encoded, the image processing apparatus 100 may have a structure in which the tuner 224 inputs the received signal to the selector 226.

The image processing apparatus 100 also includes an input terminal 228, a tuner 229, and an A/D converter 230.

The input terminal 228 is an input terminal to which, for example, an analog broadcasting signal that is received by an antenna 227 is input. The antenna 227 receives analog broadcasting signals. Specifically, the input terminal 228 receives content such as a program supplied by an analog broadcasting signal.

The input terminal 228 supplies the received analog broadcasting signal to the tuner 229. The tuner 229 is a tuner for analog broadcasting signals. The tuner 229 performs tuning (selection) of the analog broadcasting signal supplied from the antenna 227. The tuner 229 transmits the tuned analog broadcasting signal to the A/D converter 230.

The A/D converter 230 converts the analog broadcasting signal supplied from the tuner 229 into a digital signal. The A/D converter 230 inputs the converted digital broadcasting signal (content) to the selector 226.

The image processing apparatus 100 also includes an input terminal 231, and an A/D converter 232. The input terminal 231 is an input terminal for receiving analog signals. The input terminal 231 is connected to an apparatus which outputs an analog video signal and audio signal. The input terminal 231 supplies the received analog signal to the A/D converter 232.

The A/D converter 232 converts the analog signal supplied from the input terminal 231 into a digital signal. The A/D converter 232 inputs the converted digital signal to the selector 226.

The image processing apparatus 100 also includes an input terminal 233. The input terminal 233 is an input terminal for receiving digital signals, and includes, for example, an HDMI (High Definition Multimedia Interface). The input terminal 233 is connected to an apparatus which outputs a digital video signal and audio signal. The input terminal 233 is connected to, for example, an apparatus (HDMI apparatus) 261 which can transmit and receive data in the HDMI format. The input terminal 233 receives a digital signal inputted from the HDMI apparatus. The input terminal 233 supplies the received digital signal to the selector 226.

The selector 226 selects one of the digital broadcasting signal supplied from the decoder 225, the digital signal supplied from the A/D converter 230, the digital signal supplied from the A/D converter 232, and the digital signal supplied from the input terminal 233, and supplies the selected signal to a signal processor 234.

The image processing apparatus 100 also includes the signal processor 234, a control module 235, an encoder/decoder 236, an audio output circuit 237, an output terminal 238, a video output circuit 239, and an output terminal 242.

The signal processor 234 divides the input digital signal into an audio signal, a video signal, and other data (such as metadata). The signal processor 234 subjects the divided audio signal and the video signal to various signal processing.

For example, the signal processor 234 subjects the audio signal to audio decoding, sound quality control, and mixing, if necessary. In addition, the signal processor 234 subjects the video signal to color and brightness separation processing, color control processing, and image quality control processing. The signal processor 234 also subjects the video signal to control of tone, brightness, sharpness, contrast, and other image quality control processing based on, for example, control by the control module 235.

The signal processor 234 supplies the audio signal to the audio output circuit 237. The signal processor 234 also supplies the video signal to the video output circuit 239. The signal processor 234 also supplies other data to the control module 235.

The audio output circuit 237 converts the audio signal received from the signal processor 234 into an audio signal of a format which can be played back by speakers 2102. The audio output circuit 237 outputs the audio signal to the output terminal 238. The output terminal 238 outputs the supplied audio signal to the outside of the apparatus. Thereby, the speakers 2102 which are connected to the output terminal 238 play back sound based on the supplied audio signal.

The video output circuit 239 converts the video signal received from the signal processor 234 into a video signal of a format which can be played back by the three-dimensional display apparatus 1. Specifically, the video output circuit 239 decodes (plays back) the video signal received from the signal processor 234 into a video signal of a format which can be played back by the three-dimensional display apparatus 1. The video output circuit 239 outputs the video signal to the output terminal 242. The three-dimensional display apparatus 1 which is connected to the output terminal 242 displays an image based on the supplied video signal.

The image processing apparatus 100 may have a structure of including the three-dimensional display apparatus 1 inside the apparatus 100, instead of the output terminal 242. The image processing apparatus 100 may have a structure of including the speakers 2102 inside the apparatus 100, instead of the output terminal 238.

The control module 235 functions as control means for controlling operations of the modules in the image processing apparatus 100.

The control module 235 includes a CPU, a ROM, a RAM, and an EEPROM and the like. The control module 235 performs various processing based on operation signals supplied from an operation module 247 or a remote control signal receiver 248.

The CPU includes an operation element which performs various operations. The CPU realizes various functions by executing programs stored in the ROM or the EEPROM.

The ROM stores a program to control the image processing apparatus 100, and a program to realize various functions. The CPU starts a program stored in the ROM, based on an operation signal supplied from the operation module 247 or the remote control signal receiver 248. Thereby, the control module 235 controls operations of the modules.

The RAM functions as a work memory of the CPU. Specifically, the RAM stores operation results of the CPU, and data read by the CPU.

The EEPROM is a nonvolatile memory which stores various setting information items and programs.

The control module 235 includes a recording controller 235a and a playback controller 235b which are realized by the above CPU, the ROM, the RAM, and the EEPROM. The recording controller 235a controls the modules to record the signal selected by the selector 226. The playback controller 235a controls the modules to play back content recorded in the image processing apparatus 100, or content recorded in an apparatus that is connected to the image processing apparatus 100.

The control module 235 generates information (GUI item) to display an object such as GUI (graphic user interface) on the screen. The control module 235 reads a GUI item which is recorded in advance in a storage device such as the ROM and the EEPROM. In addition, the control module 235 generates a GUI item to display subtitles, the time, program information, a menu picture, or other information, based on information supplied from the selector 226. The control module 235 supplies the generated GUI items to the signal processor 234. The signal processor 234 draws various objects in the video signal, based on the GUI items supplied from the control module 235.

The image processing apparatus 100 also includes a connection terminal 244, a transmitter/receiver 245, a modulator/demodulator 246, the operation module 247, the remote control signal receiver 248, a connector 251, and a terminal 256.

The connection terminal 244 includes a connection terminal, such as a LAN port, to connect to a network. The image processing apparatus 100 may include a wireless LAN module instead of the connection terminal 244.

The transmitter/receiver 245 performs data transmission and reception with a server on a network or the like through the connection terminal 244. The modulator/demodulator 246 modulates and demodulates data which is transmitted/received by the transmitter/receiver 245. Thereby, the image processing apparatus 100 can obtain and play back content data of moving pictures on a network.

The operation module 247 is an operation input module which includes operation keys, a keyboard, a mouse, a touch pad, or other input devices that can generate an operation signal in response to an operation input. For example, the operation module 247 generates an operation signal in response to an operation input. The operation module 247 supplies the generated operation signal to the control module 235.

The touch pad includes an electrostatic sensor, a thermosensor, or a device which generates positional information based on another method. When the image processing apparatus 100 includes the three-dimensional display apparatus 1 or another display apparatus, the operation module 247 may have a structure of including a touch panel which is formed as one unitary piece with the display apparatus.

The remote control signal receiver 248 includes a sensor which receives, for example, an operation signal from a remote controller 2104. The remote control signal receiver 248 supplies the received operation signal to the control module 235. The remote controller 2104 generates an operation signal based on an operation input by the user. The remote controller 2104 transmits the generated operation signal to the remote control signal receiver 248 by infrared communication. The remote control signal receiver 248 and the remote controller 2104 may have a structure of performing transmission and reception of operation signals by another wireless communication such as optical communication and radio wave communication.

The connector 252 includes a card connector to which various memory cards can be connected. The connector 252 is an interface configured to perform communication with, for example, a memory card which stores moving picture content. The connector 252 reads moving picture content data from the connected memory card, and supplies the data to the control module 235.

The terminal 256 is a terminal to which a storage device such as a hard disk drive (HDD) 257 can be connected. The terminal 256 reads moving picture content data from the HDD 257 which stores moving picture content, and supplies the data to the control module 235.

The storage device which is connected to the terminal 256 may be a storage device such as a solid state drive (SSD) and a semiconductor memory. The image processing apparatus 100 can read and play back content which is stored in the storage device. The image processing apparatus 100 can also store content, which is supplied by a broadcasting signal or a network, in the storage device.

The image processing apparatus 100 may further include a USB connector configured to perform communication with an USB device. The USB connector supplies a signal which is supplied from the connected USB device to the control module 235.

For example, when the USB device is an operation input device such as a keyboard, the USB connector receives an operation signal from the USB device. The USB connector supplies the received operation signal to the control module 235. In this case, the control module 235 performs various processing based on the operation signal supplied from the USB connector.

In addition, for example, when the USB device is a storage device which stores moving picture content data, the USB connector can obtain the content from the USB device. The USB connector supplies the obtained content from the control module 235.

Besides, the image processing apparatus 100 may further include a disk drive. The disk drive includes a drive to which a compact disk (CD), a digital versatile disk (DVD), a blu-ray disk (BD), or another optical disk which can store moving picture content data can be attached. The disk drive reads content from the attached optical disk, and supplies the read content to the control module 235.

The image processing apparatus further includes a power source module (not shown). The power source module supplies electric power to the modules of the image processing apparatus 100. The power source module converts electric power, which is supplied through an AC adaptor or the like, and supplies the converted electric power to the modules. The power source module may include a battery. In this case, the power source module charges the battery with electric power supplied through the AC adaptor or the like. The power source module supplies the electric power of the battery to the modules of the image processing apparatus 100.

The signal processor 234 includes a three-dimensional processor 80. The three-dimensional processor 80 performs three-dimensional display based on content that includes a right-eye image and a left-eye image, between which parallax exists. The three-dimensional processor 80 processes a video signal such that the user recognizes a three-dimensional image based on a right-eye image and a left-eye image.

The three-dimensional processor 80 also performs three-dimensional display of objects such as a menu picture, program information, and alert, based on a GUI item (referred to as additional information) which is supplied from the control module 235.

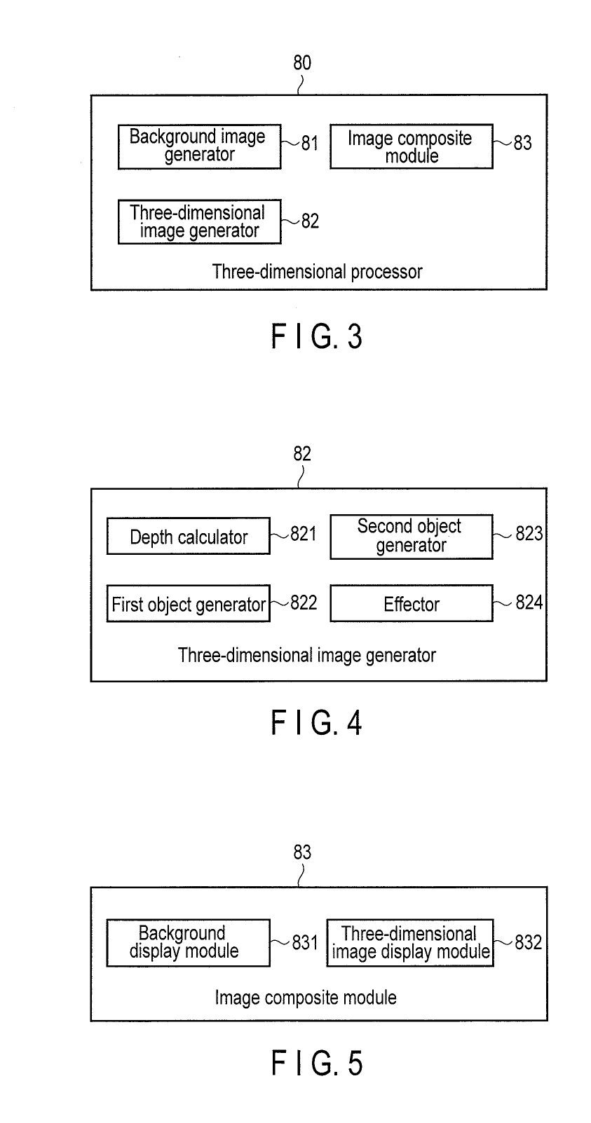

FIG. 3 is an exemplary view shown for explaining an example of a structure of the three-dimensional processor 80.

As illustrated in FIG. 3, the three-dimensional processor 80 includes a background image generator 81, a three-dimensional image generator 82, and an image composite module 83.

The background image generator 81 generates a background image to be displayed on the display screen. The background image generator 81 generates, for example, an ordinary broadcasting display picture.

The three-dimensional image generator 82 generates a three-dimensional image such that the user recognizes various objects as a three-dimensional image. The three-dimensional image generator 82 generates a three-dimensional image to display objects such as a menu picture, an EPG picture, a broadcasting mail display picture, alert, program information, and other information, based on the additional information. For example, the three-dimensional image generator 82 generates a right-eye image and a left-eye image as three-dimensional image, to perform display such that the user can recognize objects as a three-dimensional image.

The image composite module 83 combines the background image generated by the background image generator 81 with the three-dimensional image generated by the three-dimensional image generator 82. Specifically, the image composite module 83 displays the background image first, and displays the three-dimensional image in a layer which is higher (front in the display) than that of the background image.

For example, the image composite module 83 displays the background image, and displays the right-eye image and the left-eye image of the three-dimensional image in a layer higher than that of the background image. Thereby, the image composite module 83 generates a video signal which includes an object image having parallax. The method of three-dimensional image is not limited to the above method, but may be any method.

The image composite module 83 outputs the generated video signal to the video output circuit 239. The video output circuit 239 outputs the video signal that is received from the image composite module 83 to the three-dimensional display apparatus 1. Thereby, the three-dimensional display apparatus 1 displays a picture which includes the object image, in a state in which the user can recognize the picture as a three-dimensional image.

FIG. 4 is an exemplary view shown for explaining the three-dimensional image generator 82. The three-dimensional image generator 82 includes a depth calculator 821, a first object generator 822, a second object generator 823, and an effector 824.

The depth calculator 821 calculates a first depth based on a GUI item (additional information) supplied from the control module 235. When the additional information includes information which indicates a depth, the depth calculator 821 determines a first depth based on the information indicating a depth in the additional information.

In addition, the depth calculator 821 calculates a second depth to an Nth depth based on the first depth. The depth calculator 821 outputs the first depth to the first object generator 822. The depth calculator 821 also outputs the second to Nth depths to the second object generator 823.

For example, the depth calculator 821 determines the second depth to Nth depth, by performing linear operation or referring to a table in which the ratio of each of them to the first depth is preset. The depth calculator 821 calculates the second to Nth depths such that the first depth is located in the highest layer (the front in the display screen).

The depth calculator 821 may calculate the second depth to Nth depth by any method, as long as the depths are located between the first depth and the depth of the background image.

The first object generator 822 generates an image (object image) which indicates an object such as a menu picture, an EPG picture, a broadcasting mail display picture, alert, program information, and other information, based on the GUI item (additional information) supplied from the control module 235.

In addition, the first object generator 822 generates a first three-dimensional image, based on the first depth outputted from the depth calculator 821 and the object image. Specifically, the first object generator 822 generates a picture which is displayed in the front of the display screen by the image processing apparatus 100. The first three-dimensional image includes a right-eye image which is viewed by the user's right eye and a left-eye image which is viewed by the user's left eye.

The first object generator 822 determines an area in which an object image in the right-eye image is displayed, and an area in which an object image in the left-eye image is displayed. The first object generator 822 displays the object images in the determined areas, and thereby generates the first three-dimensional image. The object image displayed in the right-eye image and the object image displayed in the left-eye image have parallax. The first object generator 822 outputs the generated first three-dimensional image to the image composite module 83.

The second object generator 823 generates an image (object image) which indicates an object such as a menu picture, an EPG picture, a broadcasting mail display picture, alert, program information, and other information, based on the GUI item (additional information) supplied from the control module 235. The object image may be the same as, or different from, the object image generated by the first object generator 822.

In addition, the second object generator 823 generates a second to Nth three-dimensional images, based on the second to N depths outputted from the depth calculator 821 and the object image. Specifically, the second object generator 823 generates a picture which is displayed behind the image generated by the first object generator 822.

The second object generator 823 generates a second three-dimensional image based on the second depth outputted from the depth calculator 821 and the object image, a third three-dimensional image based on the third depth and the object image, and an Nth three-dimensional image based on the Nth depth and the object image. Each of the second to Nth three-dimensional images includes a right-eye image which is viewed by the user's right eye and a left-eye image which is viewed by the user's left eye.

The second object generator 823 determines an area in which an object image in the right-eye image is displayed, and an area in which an object image in the left-eye image is displayed, based on the second depth. The second object generator 823 displays the object images in the determined areas, and thereby generates a second three-dimensional image. The second object generator 823 generates a third to Nth three-dimensional images, by performing the same processing based on the third to Nth depths.

The object image displayed in the right-eye image and the object image displayed in the left-eye image have parallax. The second object generator 823 outputs the generated second to Nth three-dimensional images to the image composite module 83.

The effector 824 adds an effect to the object images generated by the first object generator 822 or the second object generator 823. For example, the effector 824 adds an effect based on a template which is preset in the effector 824. More specifically, the effector 824 stores in advance a pixel brightness control pattern and the like as a template. The effector 824 provides the object images with gloss, rounds the object images, or shades the object images, based on the template. Thereby, the effector 824 provides the object image being a two-dimensional image with a pseudo-three-dimensional effect.

FIG. 5 is an exemplary view shown for explaining the image composite module 83. The image composite module 83 includes a background image display module 831, and a three-dimensional image display module 832.

The image composite module 83 combines the background image generated by the background image generator 81 with the three-dimensional image generated by the three-dimensional image generator 82. The background image display module 831 displays the background image generated by the background image generator 81. In this case, the background image display module 831 displays the background image with a depth of a preset standard. The image which is displayed with the standard depth is displayed in a state where there is no parallax between the right-eye image and the left-eye image. Specifically, the background image display module 831 performs display to cause the user to recognize the image as a two-dimensional image, not a three-dimensional image. In addition, the three-dimensional image display module 832 displays the three-dimensional image generated by the three-dimensional image generator 82, in a layer which is higher (front layer in the display) than that of the background image.

As described above, the three-dimensional image generator 82 outputs the first to Nth three-dimensional images to the image composite module 83. In this case, the three-dimensional image display module 832 successively displays the three-dimensional images from the three-dimensional image which is displayed with a depth close to the depth of the back ground image. Specifically, the three-dimensional image display module 832 displays the Nth three-dimensional image first, and displays the (N-1)th three-dimensional image in a layer which is higher (front layer in the display) than that of the Nth three-dimensional image. The three-dimensional image display module 832 successively performs display to the first three-dimensional image by the same processing. As a result, the first three-dimensional image is displayed in the front.

Thereby, the image composite module 83 generates a video signal which includes an object image having parallax. The image composite module 83 outputs the generated video signal to the video output circuit 239. The video output circuit 239 outputs the video signal, which is received from the image composite module 83, to the three-dimensional display apparatus 1. Thereby, the three-dimensional display apparatus 1 displays a picture which includes an object image in a state in which the user can recognize the image as a three-dimensional image.

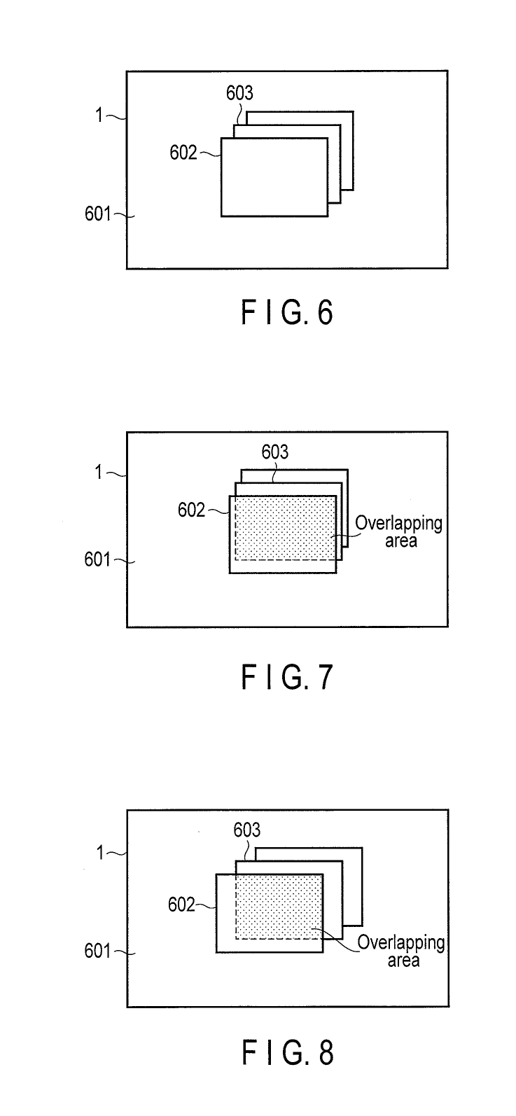

FIG. 6 is an exemplary view shown for explaining an example of a picture which is generated by the image processing apparatus 100 and displayed by the three-dimensional display apparatus 1.

A first object 602 and a second to Nth objects 603 are displayed on a screen 601 illustrated in FIG. 6. The first object 602 is an object which is displayed with the first depth that is determined by the above method, and the second to Nth objects 603 are objects which are displayed with the second to Nth depths. The first object 602 is displayed in the front, and the second to Nth objects 603 are displayed behind the first object 602. In addition, since the second to Nth objects 603 overlap the respective objects which are disposed in front of them, the second to Nth objects 603 are displayed in a state where part of the second to Nth objects 603 are hidden.

FIG. 7 is a diagram illustrating an image which is viewed by the user's left eye. FIG. 8 is a diagram illustrating an image which is viewed by the user's right eye.

As illustrated in FIG. 7 and FIG. 8, the three-dimensional display apparatus 1 displays the video signal generated by the image processing apparatus 100 by the method explained in FIG. 1, and thereby can cause the user's right eye and left eye to view images which have parallax. Thereby, it is possible to cause the user to recognize the object as a three-dimensional image.

In addition, as described above, the image processing apparatus 100 controls the display positions of the object images such that the second to Nth objects are displayed in a position overlapping the first object. Specifically, the image processing apparatus 100 controls the display positions of the first three-dimensional image to the Nth three-dimensional image, such that at least parts of the first to N objects displayed with the first to Nth depths overlap, as illustrated in FIG. 7 and FIG. 8.

As a result, the image processing apparatus 100 can cause the user to view the image in a state where the objects successively project from the inner side.

The image processing apparatus 100 may have a structure of controlling the display positions of the object images of the first three-dimensional image to the Nth three-dimensional image, such that parts of all the first to Nth objects overlap with each other. In addition, the image processing apparatus 100 may have a structure of control the display positions of the object images of the first three-dimensional image to the Nth three-dimensional image, such that parts of objects which are displayed with two adjacent depths overlap with each other.

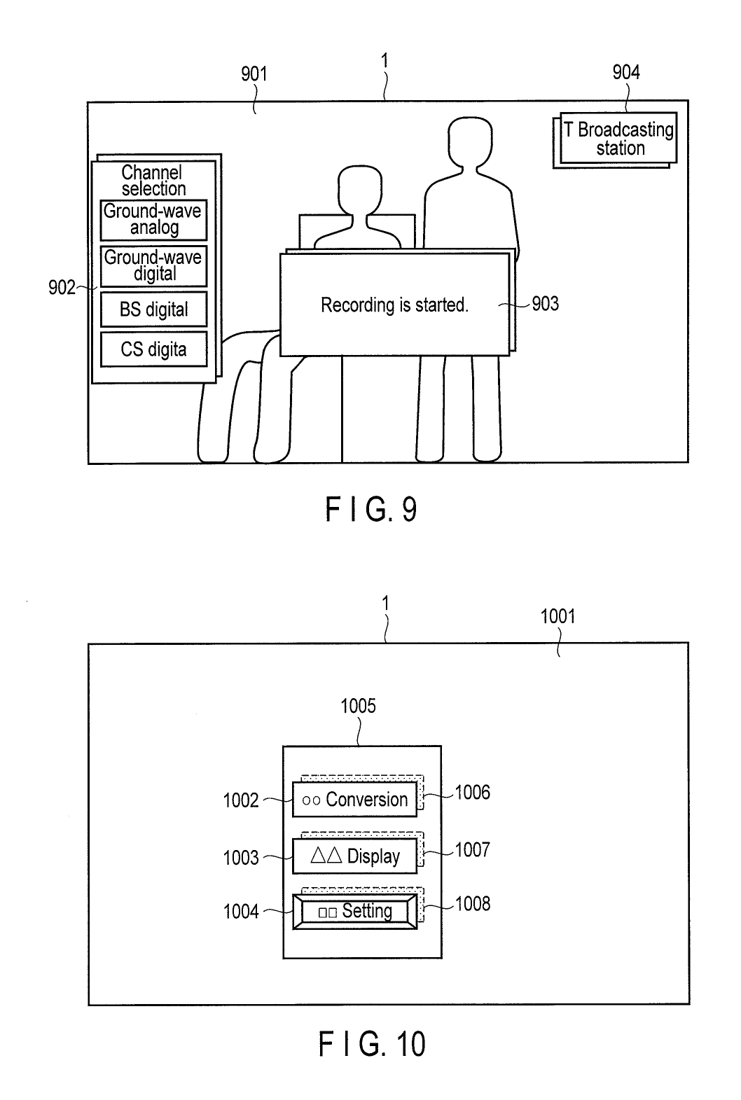

FIG. 9 is an exemplary view shown for explaining an example of a picture which is generated by the image processing apparatus 100 and displayed by the three-dimensional display apparatus 1.

As illustrated in FIG. 9, for example, a picture 901 which is generated by the image processing apparatus 100 is generated such that a menu window 902, an alert window 903, and a channel banner 904 and the like are recognized by the user as a three-dimensional image.

FIG. 10 is an exemplary view shown for explaining an example of a picture to which effects are added by the effector 824.

As illustrated in FIG. 10, a picture 1001 which is generated by the image processing apparatus 100 shows buttons 1002 to 1004, an window 1005, and shadows 1006 to 1008.

The shadows 1006 to 1008 are shadows of objects of the buttons 1002 to 1004, respectively. The shadows 1006 to 1008 are effects which are added by the effector 824 to the object image used for display of the window 1005.

The buttons 1002 to 1004 are objects which are displayed with the first depth. The window 1005 is an object which is displayed with the second depth. When shadows are added to the object image of the window 1005, the effector 824 specifies areas to which the shadows are added, based on the display positions in the case where the buttons 1002 to 1004 are displayed with the second depth. The effector 824 adds the shadows to the object image, by performing processing such as darkening the color of the pixels of the specified areas, or reducing the brightness of the pixels of the specified areas.

The button 1004 is an object to which a bulging effect is added by the effector 824. In this case, the effector 824 adds an effect to the object image of the button 1004, based on a preset template as described above. Specifically, the effector 824 provides an object image with a pseudo-three-dimensional effect by controlling the gradation and the brightness of the pixels of the object image.

As described above, the effector 824 adds a shadow of the first object (first three-dimensional image) to the object image generated by the second object generator 823. The effector 824 specifies an area, to which a shadow is to be added, based on the display area used in the case where the object image generated by the first object generator 822 is displayed with the second depth. The effector 824 adds the shadow to the specified area of the object image.

The effector 824 may have a structure of enlarging the specified area, to which the shadow is to be added, to a desired or preset size. In addition, the effector 824 may have a structure of moving the specified area within a desired or preset range.

As described above, the image processing apparatus 100 displays a plurality of objects in an overlapping state with different depths behind an object of three-dimensional display, and thereby can more effectively cause the user to recognize the objects as a three-dimensional image. Consequently, it is possible to provide an image processing apparatus and an image processing method which can more effectively display a three-dimensional image.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a background image generator configured to generate a background image;
a receiver configured to receive information;
a depth calculator configured to determine a first depth based on the information and calculate a second depth based on the first depth;
a first three-dimensional image generator configured to generate a first object image based on the information and generate a first three-dimensional image based on the first object image and the first depth;
a second three-dimensional image generator configured to generate a second object image based on the information and generate a second three-dimensional image based on the second object image and the second depth;
an image composite module configured to generate a video signal by displaying the background image, displaying the second three-dimensional image in front of the displayed background image, and displaying the first three-dimensional image in front of the displayed second three-dimensional image, at least part of the second three-dimensional image being displayed in an area overlapping the first three-dimensional image; and
an output module configured to output the video signal.

2. The image processing apparatus of claim 1, wherein
the depth calculator is configured to calculate the second depth within a range from the first depth to another depth.

3. The image processing apparatus of claim 2, wherein
the depth calculator includes a table comprising a ratio to the first depth, and the depth calculator is configured to calculate the second depth with reference to the table.

4. The image processing apparatus of claim 2, wherein
the depth calculator is configured to calculate the second depth by performing a linear operation based on the first depth.

5. The image processing apparatus of claim 2, further comprising
an effector configured to add a shadow of the first three-dimensional image to the second object image.

6. The image processing apparatus of claim 5, wherein
the effector is configured to specify an area to which the shadow is to be added, based on a display area used when the first object image is displayed with the second depth.

7. The image processing apparatus of claim 6, wherein
the effector is configured to enlarge the specified area to which the shadow is to be added, to a desired size.

8. The image processing apparatus of claim 6, wherein
the effector is configured to move the specified area to which the shadow is to be added, within a desired range.

9. The image processing apparatus of claim 2, further comprising
an effector configured to add a pseudo-three-dimensional effect to the first object image, based on a template.

10. An image processing method performed in an image processing apparatus, comprising:
generating a background image;
receiving information;
determining a first depth based on the information, and calculating a second depth based on the first depth;
generating a first object image based on the information, and generating a first three-dimensional image based on the first object image and the first depth;
generating a second object image based on the information, and generating a second three-dimensional image based on the second object image and the second depth;
generating a video signal by displaying the background image, displaying the second three-dimensional image in front of the displayed background image, and displaying the first three-dimensional image in front of the displayed second three-dimensional image, at least part of the second three-dimensional image being displayed in an area overlapping the first three-dimensional image; and
outputting the generated video signal.
